(19) United States
(12) Patent Application Publication
(10) Pub. No.: US 2016/0284363 A1
(43) Pub. Date: Sep. 29, 2016

(54) VOICE ACTIVITY DETECTION TECHNOLOGIES, SYSTEMS AND METHODS EMPLOYING THE SAME

(71) Applicant: Intel Corporation, Santa Clara, CA (US)

(72) Inventors: Alejandro Ibarra Von Borstel, Zapopan (MX); JULIO ZAMORA ESQUIVEL, Zapopan (MX); PAULO LOPEZ MEYER, Tlaquepaque (MX)

(73) Assignee: Intel Corporation, Santa Clara, CA (US)

(21) Appl. No.: 14/666,525

(22) Filed: Mar. 24, 2015

(51) Int. Cl. G10L 25/78

(52) U.S. Cl. CPC G10L 25/78

(57) ABSTRACT

Voice activity detection technologies are disclosed. In some embodiments, the voice activity detection technologies determine whether the voice of a user of an electronic device is active based at least in part on biosignal data. Based on the determination, an audio sensor may be activated to facilitate the recording of audio signals containing audio data corresponding to an acoustic environment proximate the electronic device. The audio data may be fed to a speech recognition system to facilitate voice command operations, and/or it may be used to confirm or deny a prior determination that user voice activity is present. Device, systems, methods, and computer readable media utilizing such technologies are also described.

### TECHNICAL FIELD

The present disclosure relates to voice detection technologies and, in particular, to voice detection technologies that utilize a combination of biosignals and audio signals. Devices, systems, and methods utilizing such technologies are also described.

### BACKGROUND

For many years physical interfaces such as a computer mouse, keyboard, touch screen, physical buttons, and soft buttons have been used as a primary mechanism for controlling a wide variety of electronic devices such as desktop computers, laptop computers, tablet personal computers, personal data assistants, cellular phones, and smart phones. As the capabilities and mobility of such devices has increased, interest has grown in the use of alternative mechanisms for controlling such devices. Interest has especially grown in the use of the human voice to control mobile electronic devices, particularly in instances where the form factor of the device limits or prevents the use of a robust physical interface.

By way of example, device manufactures and researchers have now developed so-called “wearable” devices such as eyewear, watches, bracelets, belt buckles, etc., which offer a variety of features to a user. Due to their form factor and in particular their size, however, it may be difficult to implement a robust physical control interface in wearable devices. Efforts have therefore been made to enable sophisticated control of wearable and other electronic devices by other means, such as through voice (auditory) commands and gesture based commands.

With the foregoing in mind speech recognition technologies have been developed to enable a user to use his or her voice to control one or more functions of an electronic device. In general such technologies analyze audio signals for speech commands, and convey any detected commands to appropriate hardware and/or software. Although these existing technologies have proven useful, they may suffer from one or more drawbacks as outlined below.

One drawback of some speech recognition systems is that they may rely on continuous monitoring of the acoustic environment in the proximity of an electronic device, which in turn may trigger continuous analysis of audio signals for voice commands. As may be appreciated, such systems may consume significant power and processing resources. This may be undesirable for certain applications such as in mobile electronic devices, where battery power is at a premium.

To address this issue, some voice control systems employ a voice activity detection system, which triggers analysis of acoustic signals by a speech recognition system only when the speech detection system detects a user's voice. For example, some existing voice activity detection systems utilize an acoustic sensor to monitor the acoustic environment proximate an electronic device. The sensor produces an audio signal which the system may process in an attempt to detect the voice of a user of the electronic device. Although somewhat effective, it may be difficult for such systems to accurately detect the presence of a user's voice in the presence of noise. For example, it may be difficult for a voice activity detection system to detect the presence of a user's voice in the presence of other voices (e.g., of non-users). Heavy breathing, loud background noise, and/or the presence of other audio data in the audio signal under analysis may also limit the ability of existing voice activity detection systems to accurately detect the voice of a user. This can lead to inconsistent performance of the voice detection system, which in turn may result in excessive or insufficient activation of a corresponding speech recognition system.

In addition and as implied by the foregoing, existing voice activity detection systems may rely on constant monitoring and analysis of audio signals for the presence of (user) voice activity. Although such systems may require fewer resources than a full blown speech recognition system, they may still consume significant power and processing resources of an electronic device.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram of the system architecture of one example of a system for detecting user voice activity consistent with the present disclosure;

FIG. 2 is a perspective view of another example of a system for detecting user voice activity in accordance with the present disclosure, as implemented in eyewear; and

FIG. 3 is a flow diagram depicting operations of one example of a method of detecting user voice activity in accordance with the present disclosure.

### DETAILED DESCRIPTION

While the present disclosure is described herein with reference to illustrative embodiments for particular applications, it should be understood that such embodiments are for the sake of example only and that the invention as defined by the appended claims is not limited thereto. Indeed for the sake of illustration the technologies described herein may be discussed in the context of one or more use models in which one or more hand gestures are recognized. Such discussions are exemplary only, and it should be understood that all or a portion of the technologies described herein may be used in other contexts and with other gestures. Those skilled in the relevant art(s) with access to the teachings provided herein will recognize additional modifications, applications, and embodiments within the scope of this disclosure, and additional fields in which embodiments of the present disclosure would be of utility.

The term “biosignal” is used herein to refer to one or more signals (e.g., voltages, currents, etc.) which may be measured from a living animal such as a human being. Non-limiting examples of biosignals include muscle activity signals (e.g., electromyography corresponding to excitement and/or actuation of one or more muscles of the human body, such as but not limited to one or more muscles of the head and/or face), brain activity signals (e.g., electroencephalography signals that may or may not correlate to excitement and/or actuation of one or more muscles in a portion of the human body such as but not limited to all or a portion of the head and/or face), combinations thereof, and the like. Information contained in such signals is referred to herein as “biosignal data.” In some embodiments, biosignal data includes one or more of electromyography data, electroencephalography (EEG) data, or a combination thereof.

The technologies described herein may be implemented using one or more electronic devices. The terms “device,” “devices,” “electronic device” and “electronic devices” are interchangeably used herein to refer individually or collectively to any of the large number of electronic devices that may be used as or in a voice detection activity system consistent with the present disclosure.

Non-limiting examples of devices that may be used in accordance with the present disclosure include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers, set-top boxes, smart phones, tablet personal computers, ultra-mobile personal computers, wired telephones, combinations thereof, and the like. Such devices may be portable or stationary. Without limitation, in some embodiments the voice activity detection technologies described herein are implemented in or with one or more mobile electronic devices, such as one or more cellular phones, desktop computers, electronic readers, laptop computers, set-top boxes, smart phones, tablet personal computers, televisions, wearable electronic devices (e.g., belt buckles, clip on devices, a headpiece, eyewear, a pin, jewelry (e.g., necklace, bracelet, anklet, earring, etc.), or ultra-mobile personal computers. In some instances, the voice activity detection technologies described herein are implemented in or with a smart phone, a wearable device, or a combination thereof.

The term “eyewear” is used herein to generally refer to objects that are worn over one or more eyes of a user (e.g., a human). Non-limiting examples of eyewear include eye glasses (prescription or non-prescription), sun glasses, goggles (protective, night vision, underwater, or the like), a face mask, combinations thereof, and the like. In many instances, eyewear may enhance the vision of a wearer, the appearance of a wearer, or another aspect of a wearer.

As used in any embodiment herein, the term “module” may refer to software, firmware, circuitry, and combinations thereof, which is/are configured to perform one or more operations consistent with the present disclosure. Software may be embodied as a software package, code, instructions, instruction sets and/or data recorded on non-transitory computer readable storage mediums, which when executed may cause an electronic device to perform operations consistent with the present disclosure, e.g., as described in the methods provided herein. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more devices, as defined previously. In some embodiments one or more of the modules described herein may be in the form of logic that is implemented at least in part in hardware to perform one or more voice activity detection operations consistent with the present disclosure.

The present disclosure generally relates to voice activity detection technologies and in particular to systems and methods for detecting activity of the voice of a user of an electronic device. As will be described in detail below, the voice activity detection technologies described herein may employ one or more biosignal sensors to produce one or more biosignals containing biosignal data. As discussed above, the biosignal data may correlate to (and therefore be representative of) brain activity, muscle activity, etc. of a user of an electronic device. For example, in some embodiments the technologies described herein may employ one or more biosensors to produce one or more biosignals containing electroencephalography (EEG) data representative of the brain activity of a user. Alternative or additionally, in some embodiments the technologies described herein may employ one or more electromyography sensors to produce electromyography data representative of the excitement and/or actuation of one or more muscles of a user.

Based at least in part on biosignal data, the technologies described herein may trigger activation of an audio sensor to capture the acoustic environment around an electronic device. As will become apparent from the following discussion, use of biosignal data to trigger activation of an audio sensor may enable the technologies described herein to detect user voice activity with improved accuracy, relative to existing voice activity detection systems. Moreover, use of biosignal data may avoid the need to continuously monitor the acoustic environment around an electronic device with an audio sensor and/or to avoid the need to continuously process such signals, thereby conserving power and/or other resources of an electronic device. In some embodiments, initiation of a speech recognition engine may be triggered at least in part based on a biosignal (e.g., containing EEG and/or electromyography data), an audio signal and/or audio data, or a combination thereof.

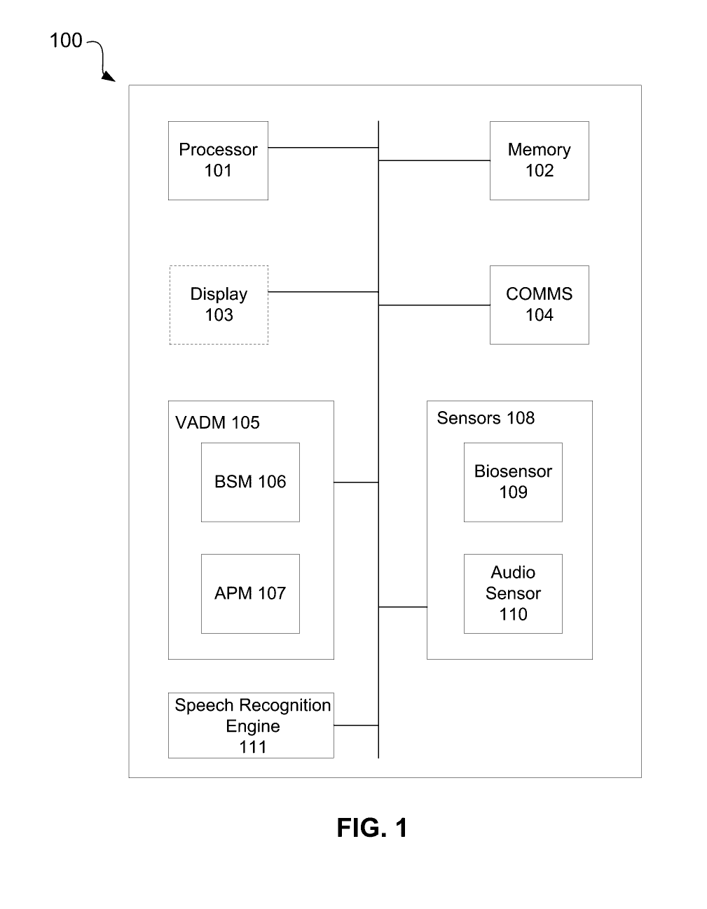

Reference is now made to FIG. 1, which is a block diagram of the system architecture of one example of a voice activity detection system consistent with the present disclosure. As shown, voice activity detection system 100 (hereinafter, system 100) includes processor 101, memory 102, optional display 103, communications (COMMS) circuitry 104, a voice activity detection module (VADM 105), sensors 108, and speech recognition engine, which may be in wired communication (e.g., via a bus or other suitable interconnects, not labeled) or wireless communication with one another.

It is noted that for the sake of clarity and ease of understanding, the various components of system 100 are illustrated in FIG. 1 and are described herein as though they are part of a single electronic device, such as single mobile device or a single wearable device. It should be understood that this description and illustration are for the sake of example only, and that the various components of system 100 need not be incorporated into a single device. For example, the present disclosure envisions embodiments in which VADM 105 may be implemented in a device that is separate from sensors 108 and/or processor 101, memory 102, optional display 103, and COMMS 104. Without limitation, in some embodiment system 100 is in the form of a mobile electronic device (e.g., a smart phone or a wearable device) that includes an appropriate device platform (not shown) that contains all of the components of FIG. 1.

Regardless of the form factor in which system 100 is implemented, processor 101 may be any suitable general purpose processor or application specific integrated circuit, and may be capable of executing one or multiple threads on one or multiple processor cores. Without limitation in some embodiments processor 101 is a general purpose processor, such as but not limited to the general purpose processors commercially available from INTEL® Corp., ADVANCED MICRO DEVICES®, ARM®, NVIDIA®, APPLE®, and SAMSUNG®. In other embodiments, processor 101 may be in the form of a very long instruction word (VLIW) and/or a single instruction multiple data (SIMD) processor (e.g., one or more image video processors, etc.). It should be understood that while FIG. 1 illustrates system 100 as including a single processor 101, multiple processors may be used.

Memory 102 may be any suitable type of computer readable memory. Example memory types that may be used as memory 102 include but are not limited to: semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally or alternatively, memory 102 may include other and/or later-developed types of computer-readable memory. Without limitation, in some embodiments memory 102 is configured to store data such as computer readable instructions in a non-volatile manner.

When used, optional display 103 may be any suitable device for display data, content, information, a user interface, etc., e.g. for consumption by a user of system 100. Thus for example, optional display may be in the form of a liquid crystal display, a light emitting diode (LED) display, an organic light emitting diode (OLED) display, a touch screen, combinations thereof, and the like.

COMMS 104 may include hardware (i.e., circuitry), software, or a combination of hardware and software that is configured to allow voice activity detection system 100 to receive and/or transmit data or other communications. For example, COMMs 104 may be configured to enable voice activity detection system 100 to receive one or more biosignals from sensors 108, e.g., over a wired or wireless communications link (not shown). Alternatively or additionally, COMMS 104 may enable system 100 to send and receive data and other signals to and from another electronic device, such as another mobile or stationary computer system (e.g., a third party computer and/or server, a third party smart phone, a third party laptop computer, etc., combinations thereof, and the like). COMMS 104 may therefore include hardware to support wired and/or wireless communication, e.g., one or more transponders, antennas, BLUETOOTH™ chips, personal area network chips, near field communication chips, wired and/or wireless network interface circuitry, combinations thereof, and the like.

As will be described in further detail below, voice activity detection system 100 may be configured to monitor at least one biosignal (e.g., corresponding to brain and/or muscle activity) of a user of an electronic device, and to detect voice activity of the user based at least in part on such biosignal. In this regard, in some embodiments voice activity detection system 100 includes voice activity detection module (VADM) 105. VADM 105 (or, more particularly, biosignal module (BSM 106 of VADM 105) in some instances may be in the form of logic implemented at least in part in hardware to receive biosignal data from biosensor 109, which may be indicative of the brain and/or muscle activity of a user of device 100.

Biosensor 109 may be any suitable sensor for taking measurements of one or more biosignals of a user of device 100. For example, in some embodiments biosensor may include or be in the form of one or more biosensors that are configured to take EEG or other brain activity measurements of a user, and in particular a human being. By way of example, biosensor 109 may include or be in the form of an biosensor that includes hardware configured to measure and/or record brain activity of a user, e.g., as detected through one or more contacts that may be placed in contact with a body part of the user, such as the user's skin. In some embodiments, the biosensor may be configured to detect and record brain activity of a user from one or more contacts placed on the user's head, such as on one or more portions of the user's face (e.g., proximate the user's temple, ear, cheek, chin, etc.). Brain activity of the user may be measured and/or recorded by the biosensor in the form of EEG data, which as noted above may be included in one or more biosignals transmitted to BSM 106.

Alternatively or additionally, biosensor 109 may include or be in the form of one or more electromyography sensors. In such instances, biosensor 109 may be configured to take electromyography or other muscle activity measurements of a user of device 100, and in particular a human being. By way of example, biosensor 109 may include or be in the form of an electromyography sensor that includes hardware configured to measure and/or record muscle activity of a user, e.g., as detected through one or more contacts that may be placed in contact with a body part of the user, such as the user's skin. In some instances the electromyography sensor may be configured to detect and record muscle activity of a user from one or more contacts placed on the user's head, such as but not limited to the portions noted above with regard to the biosensor. Muscle activity of the user may be measured and/or recorded in the form of electromyography data, which as noted above may be included in one or more biosignals transmitted to BSM 106.

It is noted that while biosensor 109 is shown in FIG. 1 as integrated with system 100 (or, more particularly, with sensors 108), such a configuration is not required. Indeed, the present disclosure envisions embodiments in which biosensor 109 is not integrated with system 100, except insofar as it may be in wired or wireless communication with system 100.

Consistent with the foregoing and as will be further described below, biosignals produced by biosensor 109 may contain EEG data and/or muscle activity (e.g. electromyography that is representative of brain and/or muscle activity of a user. In instances where the biosignals include EEG data, the EEG data may represent and/or correlate to brain activity corresponding to and/or associated with movement and/or stimulation of a body part of the user. For example, the EEG data may be representative of brain activity corresponding to and/or associated with movement and/or stimulation of all or a portion of a user's head, such as the user's face, eyes, eyebrows, nose, mouth, chin, ears, or some combination thereof. Without limitation, in some instances the EEG data is representative of brain activity corresponding to and/or associated with movement and/or stimulation of a lower part of a user's face, such as the user's mouth or chin. Such movement or stimulation may correspond to a facial gesture, such as a smirk, grin, wink, nose wrinkle, frown, smile, or the like.

Similarly, in instances where the biosignals produced by biosensor 109 include muscle activity data, the muscle activity data may represent and/or correlate to brain activity associated with the excitement and/or actuation of one or more muscles of a user. For example, the muscle activity data may be representative of the excitement and/or actuation of one or more muscles of a user's head, such as one or more facial muscles that may contribute and/or control all or a portion of the user's face (e.g., eyes, eyebrows, nose, mouth, chin, ears, combinations thereof, and the like). Without limitation, in some instances the muscle activity data is representative of muscle activity corresponding to excitement and/or actuation of one or muscles of a lower part of a user's face, such as one or more muscles contributing and/or controlling all or a portion of the user's mouth or chin. Such excitement and/or actuation may in some embodiments correspond to a facial gesture, such as a smirk, grin, wink, nose wrinkle, frown, smile, or the like.

In any case, as noted above the biosignal data may be transmitted in one or more biosignals to VADM 105 or, more specifically, to BSM 106 for analysis. As discussed below, the biosignal data may be in the form of raw sensor data (e.g., raw voltages) and/or pre-processed sensor data (e.g., raw sensor data processed by biosensor 109, e.g., into scalar value(s)).

More specifically and as shown in FIG. 1, in some embodiments VADM 105 may include BSM 106. In general, BSM 106 (or, more broadly, VADM 105) is configured to analyze biosignal data, which as noted above may be contained in a biosignal received from biosensor 109 or another location. Based at least in part on its analysis of the biosignal data, BSM 106 may make a determination as to whether user voice activity is present. In this regard, in some embodiments biosensor 109 may record brain and/or muscle activity of a user, e.g., as discussed above. biosensor 109 may then report the measured biosignal data (e.g., electrical fluctuations such as voltage or current fluctuations) as biosignal data in a biosignal to VADM 105, or more specifically, to BSM 106.

In response, BSM 106 may process the biosignal data to determine whether or not user voice activity is present. In some embodiments BSMM 106 may determine whether or not user voice activity is present by comparing at least a portion of received biosignal data (e.g., EEG and/or electromyography data) to a first threshold value, which in some embodiments may be a threshold electrical value such as a threshold voltage. For example, BSM 106 may compare the threshold electrical value to corresponding raw (unprocessed) BSM data (e.g., raw voltages) produced by biosensor 109. When BSM 106 determines that the raw EEG data (e.g., raw voltages signifying user brainwave and/or muscle activity) in the biosignal meets or exceeds the first (e.g., voltage) threshold, it may determine that user voice activity is present. Alternatively, when BSM 106 determines that the raw biosignal data in the biosignal is less than the first (e.g., voltage) threshold, it may determine that user voice activity is not present.

While the foregoing discussion focuses on BSM 106's comparison of raw biosignal data (e.g., raw voltage(s) measured by biosensor 109) in a biosignal to a first threshold, it should be understood that the use of raw biosignal data is not required. Indeed in some embodiments BSM 106 may, in response to receipt of a biosignal containing raw biosignal (e.g., EEG and/or electromyography) data, convert the raw biosignal data into one or more scalar values. In some embodiments, the scalar values may represent the degree to which raw biosignal data recorded by biosensor 109 correlates to a positive indication of movement and/or stimulation of a body part of a user of device 100. For example, BSM 106 may convert raw EEG and/or electromyography data into scalar values within a predefined range, where scalar values close to one end of the range may signify positive movement and/or stimulation of a user's body part and/or one or more muscles associated therewith. In contrast, scalar values close to the other end of the range may signify no movement and/or stimulation of the user's body part and/or associated muscles. In some embodiments, BSM 106 may convert raw biosignal (e.g., EEG and/or electromyography) data recorded by biosensor 109 to scalar values within a range of 0 to 1. In such instances, scalar values that are close to one may signify movement and/or stimulation of a user's body part and/or associated muscles, whereas scalar values close to zero may signify no movement and/or stimulation of the user's body part and/or associated muscles.

Alternatively or additionally, in some embodiments biosensor 109 may itself be configured to convert raw biosignal data (e.g., raw voltages) into scalar values. In such instances, conversion of raw biosignal data to scalar values by BSM 106 may be omitted, as biosensor 109 may transmit a biosignal containing such scalar values to BSM 106.

In any case where scalar values are used, it should be understood that the first threshold may be a threshold scalar value that may fall within the range of scalar values employed. In the foregoing example, a range of 0 to 1 is used, and so the threshold scalar value may fall within that same range. Of course, any suitable range of scalar values may be used. In any case, BSM 106 may determine that user voice activity is present when at least one scalar value in the biosignal meets or exceeds the threshold scalar value. Conversely when scalar values in the biosignal do not exceed the threshold scalar value, BSM 106 may determine that user voice activity is not present.

In some embodiments, BSM 106 may compare raw EEG data and/or scalar values in or produced from an EEG signal over a defined period of time to the first threshold. For example, BSM 106 may apply a temporal filter function to aggregate raw EEG data of biosensor 109 (or scalar values produced therefrom) over a defined period of time, such as a predefined period of microseconds, milliseconds, or even one or more seconds. In some embodiments, BSM 106 may aggregate raw EEG data of biosensor 109 (or scalar values produced therefrom) over a period of greater than 0 to about 5 seconds, such as greater than 0 to about 1 second, greater than 0 to about 500 milliseconds, or even from greater than 0 to about 100 milliseconds.

In some embodiments BSM 106 and/or biosensor 109 may collect and determine an average (e.g., an arithmetic mean, weighted mean, etc.) of the raw biosignal data of biosensor 109 (or scalar values produced therefrom) over one or more of the above noted periods of time. In such instances, BSM 106 may compare the average of the raw biosignal data (or average scalar value) to the first threshold. Consistent with the foregoing discussion, if the average of the raw biosignal data (or average scalar value) meets or exceeds the first threshold, BSM 106 may determine that user voice activity is present. Alternatively, if the average of the raw biosignal data (or average scalar value) is less than the first threshold, BSM 106 may determine that user voice activity is not present. As may be appreciated, use of the time filter function (and in particular the average of the raw biosignaldata/scalar values) may improve the accuracy of BSM 106's determination of the presence or absence of user voice activity, e.g., by limiting or even eliminating the impact of outliers that may be present in the raw sensor data produced by biosensor 109, or scalar values produced therefrom.

Alternatively or additionally, in some embodiments BSM 106 and/or biosensor 109 may determine a scalar value for comparison to the threshold, wherein the scalar value is based on a combination of the raw and/or scalar value correlating to entire or substantially the entire history of biosignal data (e.g. from the time the recording of biosignal data of a user was first instituted to a particular time, e.g., when biosignal data is sampled) and the raw or scalar value of biosignal data at a particular time. For example, BSM 106 and/or biosensor 109 may determine a scalar in accordance with the formula: Z=a(X)+b(Y), where: Z is the scalar value to be compared to the threshold; a is a percentage value ranging from greater than 0 to less than 1, X is a value or scalar representing a characteristic (e.g., intensity, average intensity, etc.) of biosignal data over the entire history (or substantially the entire history) of the measurement of biosignals from a user, b is a percentage value ranging from greater than 0 to less than 1, Y is a value or scalar of biosignal data of a user at a particular point in time; and a+b=1. In such instances, BSM 106 may compare the value of Y to the threshold value to determine whether or not voice activity is present, consistent with the foregoing discussion.

If BSM 106 determines that voice activity of a user is not present, it may continue to evaluate biosignal data of biosensor 109 against the first threshold, e.g., until system 100 is deactivated or user voice activity is determined to be present. In the latter case, in response to determining that user voice activity is present, BSM 106 may cause system 100 to initiate monitoring of the acoustic environment surrounding system 100 or, in some instances, an electronic device in which system 100 is implemented. For example, in response to determining that user voice activity is present, BSM 106 may cause system 100 to turn an audio sensor (e.g., audio sensor 110) from an OFF (or low power) state to an ON state. Thus as may be appreciated, audio sensor 110 may remain in an OFF or low power state until BSM determines that user voice activity is present. In this way, system 100 may limit power consumption by limiting the activity of audio sensor 110 and, therefore, the activity of a downstream speech recognition system.

Alternatively, in some embodiments device 100 may be configured such that audio sensor 110 may continuously monitor an acoustic environment, such that audio information from that environment is stored, e.g., in a buffer. In such instances, if BSM 106 determines that voice activity is present, it may cause system 100 to initiate processing of the audio information, e.g. to determine whether one or more voice commands are present therein. As may be appreciated, this may conserve power by limiting or even eliminating the processing of audio information when voice activity is not detected, while still allowing device 100 to obtain and/or retain audio information in periods when voice activity is not detected.

In any case, audio sensor 110 may be any suitable type of audio sensor. As non-limiting examples, of suitable audio sensors that may be used as audio sensor 110, mention is made of microphones, such as but limited to liquid microphones, carbon microphones, fiber optic microphones, dynamic microphones, ribbon microphones, laser microphones, condenser microphones such as an electret microphone, cardioid microphones, crystal microphones, and microelectromechanical machine (MEMS) microphones. Without limitation, in some embodiments audio sensor 110 is an electret microphone.

In response to one or more commands from BSM 106 (e.g., to turn ON), audio sensor 110 may capture and/or record the acoustic environment around system 100, and produce an audio signal representative of the acoustic environment. As may be appreciated, when audio sensor 109 is turned OFF or is in a low power state (e.g., when BSM 106 determines that user voice activity is not present), it may not produce an audio signal.

With the foregoing in mind, in some embodiments a determination by BSM 106 that user voice activity is present may be sufficient to instigate processing of audio signals (e.g., from audio sensor 110) by a speech recognition system within or coupled to voice activity detection system 100. This concept is illustrated in FIG. 1, which depicts system 100 as including speech recognition engine 111. It should be understood that speech recognition engine 111 need not form part of system 100, and may be coupled or otherwise in communication with system 100, as desired. For example, speech recognition engine 111 and system 100 may be integrated into the same electronic device, but as separate components. Alternatively, system 100 may be integrated into a first electronic device (e.g., a mobile and/or wearable device), and speech recognition engine 111 may be integrated into a second electronic device (e.g., a remote server).

Regardless of where speech recognition engine 111 is located, audio sensor 110 may produce an audio signal, e.g., in response to being turned ON. Alternatively and as discussed above, audio sensor 110 may continuously or nearly continuously produce an audio signal, in which case BSM 106 may control when the audio signal is processed. In any case the audio signal may contain audio data, and may be conveyed to speech recognition engine 111 for processing. For example, audio sensor 110 may transmit audio signals containing audio data to speech recognition engine 111 via a wired or wireless communication protocol. Alternatively or additionally, audio sensor 110 may produce audio data which may be stored in one or more buffers (not shown) of system 100. In any case, speech recognition system 111 may obtain (e.g., sample) the audio data from a portion of a received audio signal, such as from an audio buffer that may be integrated with or separate from system 100. Speech recognition engine 111 may then process the audio data (e.g., using voice recognition technologies well understood in the art) to determine whether it contains one or more voice commands for controlling system 100 and/or a device into which system 100 is incorporated.

It is noted that to conserve power or for other reasons, BSM 106 in some embodiments may cause system 100 to turn audio sensor 110 ON for a limited period of time in response to a determination (by BSM 106) that user voice activity is present. For example, in some embodiments BSM 106 may cause system 100 to turn audio sensor 110 ON for a period ranging from greater than 0 to about 10 seconds, such as from greater than 0 to about 5 seconds, from greater than 0 to about 1 seconds, or even from greater than 0 to about 500 milliseconds. Of course such time periods are listed for the sake of example only, and it should be understood that BSM 106 may be configured to cause system 100 to turn audio sensor 106 ON for any suitable period of time. In some embodiments, BSM 106 causes system 100 to turn audio sensor 106 ON for a period of time that is sufficient for speech recognition engine 111 to determine whether any voice commands are contained in audio data recorded by audio sensor 110. Alternatively, BSM 106 may cause system 100 to turn audio sensor 110 ON for a period of time that is sufficient to allow it to record enough of the acoustic environment around system 100 (or a device containing system 100) to enable other components of system 100 to verify or deny BSM's determination of the presence of user voice activity, as discussed below.

In some embodiments a determination by BSM 106 that user voice activity is present may not be sufficient by itself to instigate speech recognition operations, e.g., by speech recognition engine 111. Rather in such embodiments, a determination by BSM 106 that user voice activity is present may trigger additional operations by system 100 to verify the presence of user voice activity prior to initiating speech recognition operations. For example, in some embodiments instances upon determining that user voice activity is present, BSM 106 may cause system 100 to turn audio sensor 110 ON. However instead of transmitting audio data to speech recognition engine 111 for processing, audio sensor 110 may transmit audio data (e.g., via audio signals and/or an audio buffer) to VADM 105 or, more particularly, to audio processing module (APM) 107 for analysis. In this regard, BSM 106 may also cause system 100 to initiate APM 107, e.g., in instances where APM 107 may be in a low power or OFF state.

In general APM 107 may be configured to receive audio data e.g., from an audio signal and/or an audio buffer (not shown) that is integral with or separate from system 100. For example, APM 107 may sample at least a portion of audio data in a received audio signal and/or stored in an audio buffer. In such instances APM 107 may analyze the (sampled) audio data, and verify or deny BSM 106's determination that user voice activity is present based at least in part on the (sampled) audio data.

In some embodiments APM 107 may verify or deny EEG 106's determination that user voice activity is present by comparing characteristics of audio data (e.g., from an audio signal and/or buffer) to a second threshold value. For example, APM 107 may perform signal processing operations on received audio data to segregate voices therein (if any) from background or other noise. If one or more voices is/are contained in the audio data, APM 107 in some embodiments may determine the intensity or other characteristics of each voice, and compare the intensity of each voice to a second threshold, e.g., a threshold intensity value. When APM 107 determines that the intensity or other determined characteristics of a voice in a received audio signal and/or audio data meets or exceeds the second (e.g., intensity) threshold, it may confirm BSM 106's determination that user voice activity is present. Alternatively, when APM 109 determines that the intensity or other determined characteristics of a voice in a received audio signal and/or audio data is less than the second (e.g., intensity) threshold, it may deny BSM 106's determination that user voice activity is present.

In some embodiments, APM 107 may be configured to aggregate characteristics of audio data such as the intensity of an isolated voice in an audio signal over a defined period of time, and to compare such aggregated characteristics to the first threshold. For example, APM 107 may apply a temporal filter function to aggregate audio data of audio sensor 110 and/or characteristics of an isolated voice therein over a defined period of time, such as a predefined period of microseconds, milliseconds, or even one or more seconds. In some embodiments, APM 107 may aggregate audio data such as the intensity of other characteristics of an isolated voice in an audio signal produced by audio sensor 110 over a period of greater than 0 to about 5 seconds, such as greater than 0 to about 1 second, greater than 0 to about 500 milliseconds, or even from greater than 0 to about 100 milliseconds.

For example, APM 107 may collect and determine an average (e.g., an arithmetic mean, weighted mean, etc.) of characteristics of audio data (such as the intensity of a voice) in an audio signal or buffer, wherein the audio data was collected over the above noted time periods. In such instances, APM 107 may compare the average of the characteristics of the audio data to the second threshold. In specific non-limiting embodiments, the characteristics of the audio data may be an average intensity of a voice in an audio signal recorded over a defined period of time, and APM 107 may compare the average intensity of the voice to the second threshold, in this case an intensity threshold. Consistent with the foregoing discussion, if the average intensity of the voice meets or exceeds the second threshold, APM 107 may confirm BSM 106's determination that user voice activity is present. Alternatively, if the average intensity of the voice is less than the second threshold, APM 107 may deny (overturn) BSM 106's determination that user voice activity is present. In the latter case, control may return to BSM 106, which may continue to monitor and evaluate EEG data in EEG signals from biosensor 109 to determine whether user voice activity is present. In the former case, APM 107 or, more generally, VADM 105 may cause system 100 to turn or keep audio sensor 110 ON, and to apply speech recognition engine 111 to process audio data recorded by audio sensor 110 for voice commands, as discussed above.

Alternatively or additionally, in some embodiments APM 107 may determine a scalar value of the audio data for comparison to the second threshold, wherein the scalar value is based on a combination of the raw and/or scalar value correlating to entire or substantially the entire history of audio data (e.g. from the time the recording of audio data was first instituted to a particular time, e.g., when audio data is sampled) and the raw or scalar value of audio data at a particular time. For example, APM 107 may determine a scalar in accordance with the formula: C=d(E)+f(G), where: C is the scalar value of the audio data to be compared to the threshold; d is a percentage value ranging from greater than 0 to less than 1, E is a value or scalar representing (e.g., of intensity, average intensity, etc.) of audio data over the entire history (or substantially the entire history) of the measurement of audio data, f is a percentage value ranging from greater than 0 to less than 1, G is a value or scalar of audio data at a particular point in time; and d+f=1. In such instances, APM 107 may compare the value of C to the second threshold value to confirm or deny BSM 106's determination that voice activity is present.

As may be appreciated, use of the time filter function (and in particular the average of the audio characteristics over time) may improve the accuracy of APM 107's confirmation or denial of BSM's determination of the presence of user voice activity, e.g., by limiting or even eliminating the impact of outliers that may be present in the audio data produced by audio sensor 110. Similarly, use of APM 107 to confirm or deny BSM 106's determination may generally improve the ability of system 100 to detect the presence of user voice activity, e.g., by catching or even eliminating false positive detections that may be reported by BSM 106 alone.

As noted previously, the voice activity detection systems described herein may be particularly suitable for implementation in one or more electronic devices, and in particular wearable devices. For the sake of example, the present disclosure will now proceed to describe an embodiment in which a voice detection system consistent with the present disclosure is implemented in a wearable device, namely a wearable computer in the form of so-called “smart” glasses (also known as a digital eye glass or a personal imaging system). It should be understood however that the voice activity detection technologies described herein may be implemented in any suitable electronic device, including but not limited to any suitable wearable device.

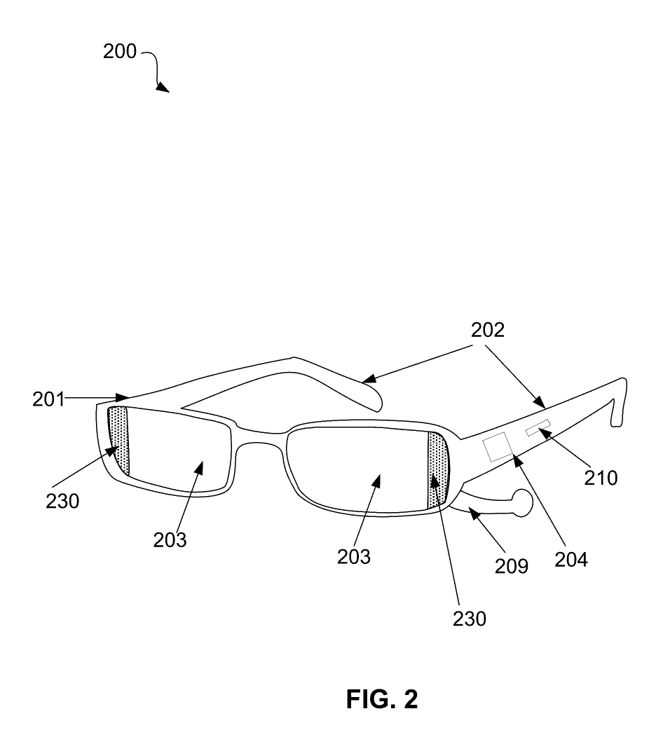

With the foregoing in mind, reference is made to FIG. 2, which depicts one example of a wearable device including voice activity detection technology consistent with the present disclosure. In this embodiment, device 200 is in the form of a wearable computer having an eyewear form factor. Among other things, device 200 may provide advanced computing and or imaging capabilities to its wearer. For example, device 200 may be outfitted with one or more digital cameras, wireless communications circuitry, etc. (not shown for the purpose of clarity) so as to provide a wide variety of capabilities to its wearer. All or a portion of such functions may be controlled via a human to computer interaction system, such as a voice control system as noted above. The nature of such functions and the use of a voice control system in such a form factor are well understood, and therefore are not described in detail herein.

As shown in FIG. 2, device 200 may include frame 201, a pair of arms 202, and lenses 203. For the sake of clarity, device 200 is illustrated in FIG. 2 in the form of eye glasses having two lenses 203 and two arms 202. It should be understood that the illustrated configuration is for the sake of example only, and that device 200 may take another form. For example, device 200 in some embodiments may include a single lens, e.g., as in the case of a monocle.

As further shown, device 200 may include processing module 204. In general, processing module 204 may be configured to perform all or a portion of the operations described above in connection with processor 101, memory 102, COMMS 104, VADM 105, and speech recognition engine 111 of FIG. 1. The operation of processing module 204 is therefore not reiterated, as it is generally the same as the operations discussed above with regard to processor 101, memory 102, COMMS 104, VADM 105, and speech recognition engine 111. Of course, it should be understood that device 200 need not include all of such components in a single component (i.e., in processing module 204), and that the foregoing elements may be positioned on or within device 200 in any suitable manner and at any suitable location.

As further shown, in the embodiment of FIG. 2 device 200 includes optional display 230, which in this case is illustrated as forming a portion of both of lenses 203. It should be understood that this illustration is for the sake of example, and the display 230 may be omitted from device 200 or implemented in a different manner. As the operation of display 230 is the same as optional display 103 of FIG. 1, a detailed description of the operation of display 230 is not reiterated. Other display configurations and form factors may of course be used.

In addition to the foregoing components, device 200 also includes biosensor 209. It is noted that for the sake of clarity and ease of illustration, FIG. 2 depicts an embodiment in which a single biosensor 209 is used and is positioned on device 200 such that a contact thereof may be in contact with the skin that is proximate the temple of a wearer. It should be understood that this illustration is for the sake of example only, and that any suitable number and placement of biosensors may be used. For example, the present disclosure envisions embodiments in which a second biosensor is used, and is positioned on, within, or is otherwise coupled to the opposite arm 202 from biosensor 209. The present disclosure also envisions embodiments in which one or more biosensors are configured to with one or more contacts that are to contact the skin proximate the cheek and/or the jaw of a wearer of device 200.

Regardless of its configuration, biosensor 209 operates in the same or similar manner as biosensor 109 of FIG. 1. That is, biosensor 209 generally operates to measure and record biosignal data of a user, and to report that data to a processing module 204 (or, more specifically, a BSM thereof) for analysis. Consistent with the foregoing discussion, biosensor 209 in some embodiments may transmit a biosignal containing biosignal data to processing module 204 or, more particularly, a BSM thereof. Alternatively biosensor 209 may transmit biosignal data to a buffer (not shown), whereupon the data may be obtained by processing module 204 (or a biosensor thereof) in the same manner as described above in connection with FIG. 1. In either case, the BSM may determine whether user voice activity is present based at least in part on the biosignal data. Further details regarding the operation of biosensor 209 may be found in the discussion of biosensor 109 of FIG. 1, and therefore are not reiterated.

Finally, as shown in FIG. 2 device 200 may include audio sensor 210. It is noted that for the sake of clarity and ease of illustration, FIG. 2 depicts an embodiment in which a single audio sensor 210 is used and is positioned on one arm 202 of device 200. It should be understood that this illustration is for the sake of example only, and that any suitable number and placement of audio sensors may be used. For example, the present disclosure envisions embodiments in which a second audio sensor is used, and is positioned on, within, or otherwise coupled to the opposite arm 202 from audio sensor 210. The present disclosure also envisions embodiments in which a plurality of audio sensors may be used, and may be positioned on, at, or within myriad locations of device 200.

Regardless of its configuration, audio sensor 210 operates in the same or similar manner as audio sensor 110 of FIG. 1. Accordingly, audio sensor 210 may be turn ON in response to a determination by processing module 204 (or, more particularly, a BSM thereof) that user voice activity is present based on an analysis of biosignal data. Subsequently, audio sensor 210 may monitor the acoustic environment around device 200, and generate audio data representative of that environment. In some embodiments, the audio data may be directed to a speech recognition engine (e.g., within processing module 204) for analysis, as discussed above. Alternatively the audio data may be directed to an audio processing module within processing module 204, as also discussed above. In the latter case, the audio processing module may analyze the audio data to confirm or deny a prior determination (e.g., by a BSM of processing module 204) that user voice activity is present.

If the analysis confirms the prior determination, speech recognition operations may be performed (e.g., by a speech recognition engine) on audio data obtained by audio sensor 210, e.g., in an attempt to identify voice commands pertaining to one or more capabilities of device 200. If the analysis denies the prior determination (i.e., indicates that user voice activity is not present), audio sensor 210 may switch to an OFF state and control may return to the BSM of processing module 204, which may continue to monitor biosignal data produced by biosensor 209.

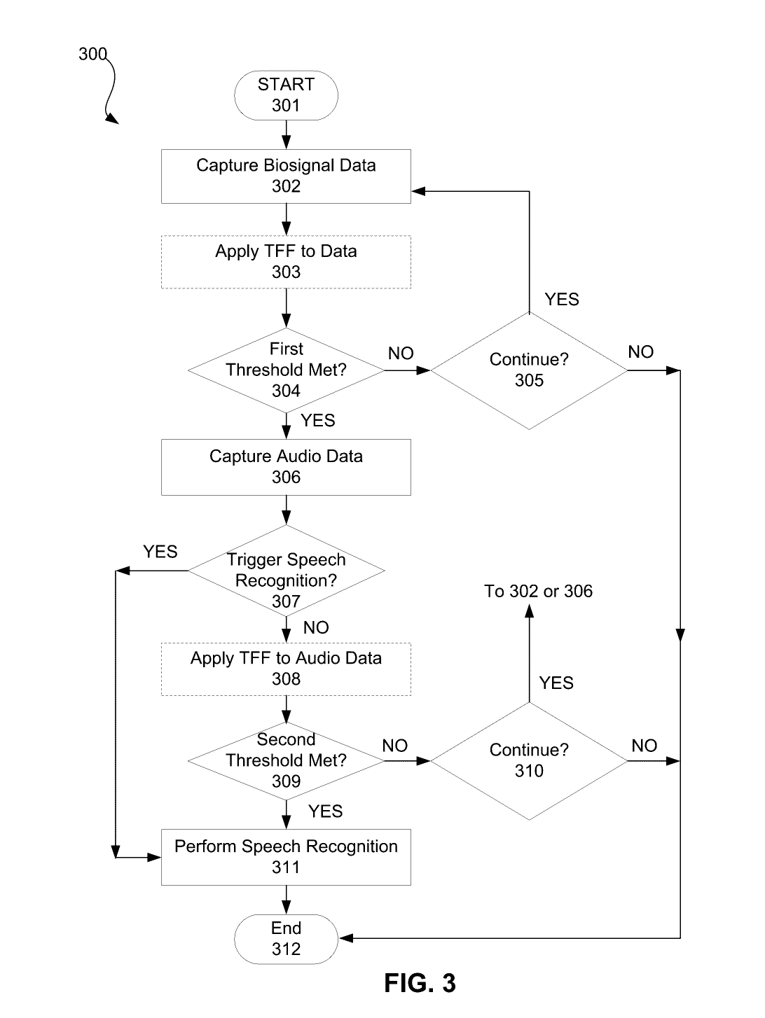

Another aspect of the present disclosure relates to methods for detecting user voice activity. In this regard reference is made to FIG. 3, which is a flow diagram of example operations of one example of a voice activity detection method consistent with the present disclosure. As shown, method 300 begins at block 301. The method may then proceed to block 302, wherein biosignal data may be collected from a user of an electronic device. As discussed above, the biosignal data may be collected by a biosensor, e.g., in response to movement and/or stimulation of a body part of the user, such as a portion of the user's face. The biosignal data may then be communicated to a BSM for analysis, as discussed above. As discussed above, the biosignal data may be in the form of raw biosignal data or in the form scalar values obtained from the raw biosignal data.

Once biosignal data has been collected, the method may proceed to optional block 303, wherein a time filter function (TFF) or other function may be applied to aggregate the biosignal data (or scalars thereof). The application of a time filter function or other function to aggregate EEG data is discussed above in connection with FIG. 1, and therefore is not reiterated.

Once the time filter function has been applied or if application of a time filter function is not required, the method may proceed to block 304. Pursuant to block 304, the raw biosignal data or scalar(s) obtained therefrom may be compared to a first threshold, and a determination may be made as to whether the data (or scalar(s) obtained therefrom) meet(s) or exceed(s) the first threshold, as generally discussed above. If not, the method may proceed to block 305, wherein a determination may be made as to whether the method is to continue. The outcome of block 305 may be conditioned, for example, on a time limit or some other parameter. If the method is to continue, it may loop back to block 302 and additional biosignal data may be collected. If the method is not to continue, it may proceed from block 305 to block 312 and end.

Returning to block 304, if it is determined that the first threshold is met or exceeded, user voice activity may be considered detected and the method may proceed to block 306. Pursuant to block 306, an audio sensor may be turned ON from a low power or OFF state, and audio data corresponding to an acoustic environment may be captured. Details of the capture of audio data by an audio sensor have been discussed previously in connection with FIG. 1 and therefore are not reiterated.

Once audio data has been captured the method may proceed to block 307, wherein a determination may be made as to whether speech recognition operations are to be applied to the audio data without further processing. If so, the method may proceed to block 311, pursuant to which a speech recognition engine may be activated and applied to perform speech recognition operations on the audio data, as discussed in detail above in connection with FIG. 1. However if further processing of the audio data is desired prior to performing speech recognition operations, the method may proceed from block 307 to optional block 308. Pursuant to optional block 308, a time filter function (TFF) or other function may be applied to aggregate the audio data. The application of a time filter function or other function to aggregate audio data is discussed above in connection with FIG. 1, and therefore is not reiterated.

Once the TFF or other function has been applied or if application of such a function is not required, the method may proceed to block 309. Pursuant to block 309 and as described above in connection with FIG. 1, at least one characteristic of the audio data may be compared to second threshold for the purpose of validating or denying the prior determination that user voice activity has been detected. As noted previously, the second threshold in some embodiments may be a threshold intensity value, which may be compared to the intensity of individual voices within the audio data recorded pursuant to block 306.

If the characteristic(s) of the audio data do not meet or exceed the second threshold, it may be determined that the initiation determination that user voice activity is present (pursuant to block 304) was in error. In such instance the method may proceed from block 309 to block 310, pursuant to which a determination may be made as to whether the method is to continue. The outcome of block 310 may be conditioned, for example, on a timeout or some other parameter. If the method is to continue, it may proceed from block 310 to block 302 or block 306, as desired. In the former case (returning to block 302), additional biosignal data may be acquired. In the latter case (returning to block 306, additional audio data may be captured. If the method is not to continue, however, it may proceed from block 310 to block 312 and end.

Returning to block 309, if it is determined that the at least one characteristic of the audio data meets or exceeds the second threshold, the prior determination (pursuant to block 304) that user voice activity is present may be confirmed. In such instance the method may proceed from block 309 to block 311. Pursuant to block 311, all or a portion of the audio data captured pursuant to block 306 may be processed by a speech recognition engine, e.g., for the presence of one or more voice commands. Following block 311, the method may proceed to block 312 (as shown in FIG. 3), or it may loop back to block 302 or block 306, as desired. For example if one or more voice commands is or is not detected in the audio data, the method may return to block 306, wherein additional audio data may be recorded.

### EXAMPLES

The following examples illustrate additional embodiments of the present disclosure.

### Example 1

According to this example there is provided a voice activity detection system, including: a processor; a memory; a biosensor; an audio sensor; and a voice activity detection module (VADM), wherein the VADM is to: receive biosignal data recorded by the biosensor determine whether a voice of a user of an electronic device is active based at least in part on an analysis of the biosignal data; and when the VADM determines that the voice of the user is active, the VADM is to cause the audio sensor to capture audio data from an acoustic environment proximate the electronic device.

### Example 2

This example includes all or a portion of the features of example 1, wherein: the biosensor is in wired or wireless communication with the voice activity detection system and produces an biosignal containing the biosignal data; and the VADM is further to receive the biosignal and determine whether the voice of the user is active based at least in part on the biosignal data in the biosignal.

### Example 3

This example includes all or a portion of the features of any one of examples 1 to 3, wherein: the VADM is to determine whether the voice of the user is active based at least in part on a comparison of a value of at least one characteristic of the biosignal data to a first threshold; and when the VADM determines that the value of the at least one characteristic of the biosignal data meets or exceeds the first threshold, it causes the audio sensor to turn ON and produce an audio signal containing audio data corresponding to the acoustic environment; and when the VADM determines that the value of the at least one characteristic of the biosignal data is less than the first threshold, the audio sensor remains in the OFF or low power state.

### Example 4

This example includes all or a portion of the features of example 3, wherein the value of the at least one characteristic of the biosignal data is an average of a plurality of individual values of the biosignal data determined over a defined period of time.

### Example 5

This example includes all or a portion of the features of example 4, wherein: each of the plurality of individual values includes a voltage; the value of the biosignal data is an average scalar value; and the average scalar value corresponds to an average of the voltage of each of the plurality of individual values.

### Example 6

This example includes all or a portion of the features of any one of examples 1 to 5, wherein the biosignal data corresponds to movement of a body part of the user.

### Example 7

This example includes all or a portion of the features of any one of examples 1 to 6, wherein the biosignal data includes electroencephalography data, electromyography data, or a combination thereof.

### Example 8

This example includes all or a portion of the features of example 6, wherein the body part includes at least a portion of the user's face.

### Example 9

This example includes all or a portion of the features of example 8, wherein the portion of the user's face is the lower part of the user's face.

### Example 10

This example includes all or a portion of the features of example 3, wherein the VADM is further to determine whether the voice of the user is active based at least in part on the audio data.

### Example 11

This example includes all or a portion of the features of example 10, wherein when the value of the at least one characteristic of the biosignal data meets or exceeds the first threshold, the VADM is further to: compare an intensity value of the audio data to a second threshold; confirm that voice activity of the user is present when the intensity value of the audio data is greater than or equal to the second threshold; and deny that voice activity of the user is not present when the intensity value of the audio data is less than the second threshold

### Example 12

This example includes all or a portion of the features of example 11, wherein the intensity value of the audio data is an average of a plurality of individual intensity values recorded over a defined period of time.

### Example 13

This example includes all or a portion of the features of any one of examples 1 to 12, wherein the system is in the form of a mobile electronic device.

### Example 14

This example includes all or a portion of the features of example 13, wherein the mobile electronic device is in the wearable electronic device.

### Example 15

This example includes all or a portion of the features of example 14, wherein the wearable electronic device is selected from the group consisting of eyewear, a watch, a belt buckle, a bracelet, a tie, and a pin.

### Example 16

According to this embodiment there is provided a method of detecting the activity of a voice of a user with electronic device, including: receiving a biosignal containing biosignal data from an biosensor; determining, with a voice activity detection module (VADM) of the electronic device, whether the voice of the user is active based at least on an analysis of the biosignal data; and when the VADM determines that the voice of the user is active, causing an audio sensor of the electronic to turn ON from an OFF or low power state, and to record an acoustic environment proximate the electronic device.

### Example 17

This example includes all or a portion of the features of example 16, wherein the VADM determines whether the voice of a user is active at least in part by: determining a value of at least one characteristic of the biosignal data; and comparing the value of the at least one characteristic of the biosignal data to a first threshold; wherein: when the value of the at least one characteristic of the biosignal data is greater than or equal to the first threshold, the method further includes: causing the audio sensor to produce an audio signal containing audio data corresponding to the acoustic environment; and when the value of the at least one characteristic of the biosignal data is less than the first threshold, the audio sensor remains in the OFF or low power state.

### Example 18

This example includes any or all of the features of example 17, wherein determining the value of the at least one characteristic of the biosignal data includes averaging a plurality of individual values of the biosignal data over a period of time.

### Example 19

This example includes any or all of the features of example 18, wherein: each of the plurality of individual values includes a voltage; the value of the biosignal data is an average scalar value; and determining the value of the at least one characteristic of the biosignal data includes: converting the voltage of each of the plurality of individual values to a corresponding of scalar value, resulting in a plurality of scalar values; and averaging the plurality of scalar values to determine the average scalar value.

### Example 20

This example includes any or all of the features of example 17, and further includes producing the biosignal signal in response to movement of a body part of the user.

### Example 21

This example includes any or all of the features of example 20, wherein the body part includes at least a portion of a face of the user.

### Example 22

This example includes any or all of the features of example 21, wherein the body part includes a lower part of the face of the user.

### Example 23

This example includes any or all of the features of any one of examples 16 to 22, wherein the biosignal data includes electroencephalography data, electromyography data, or a combination thereof.

### Example 24

This example includes any or all of the features of any one of examples 16 to 23, wherein detecting the voice activity of the user is based at least in part on the audio data.

### Example 25

This example includes any or all of the features of example 17, wherein when the value of at least one characteristic of the biosignal data is greater than or equal to the first threshold, the method further includes: comparing an intensity value of the audio data to a second threshold; confirming that voice activity of the user is present when the intensity of the sampled audio signal is greater than or equal to the second threshold; and denying that voice activity of the user is present when the intensity of the sampled audio signal is less than the second threshold.

### Example 26

This example includes any or all of the features of example 25, wherein the intensity value is an average of a plurality of individual intensity values measured over a defined period of time.

### Example 27

This example includes any or all of the features of example 25, wherein: when voice activity of the user is confirmed, the method further includes initiating the capture of the voice of the user with the audio sensor; and when voice activity of the user is denied, the method further includes returning to monitoring the biosignal.

### Example 28

This example includes any or all of the features of any one of examples 16 to 27, wherein the electronic device is a mobile electronic device.

### Example 29

This example includes any or all of the features of example 28, wherein the mobile electronic device is a wearable electronic device.

### Example 30

This example includes any or all of the features of example 29, wherein the wearable electronic device is selected from the group consisting of eyewear, a watch, a belt buckle, a bracelet, a tie, and a pin.

### Example 31

According to this example there is provided a computer readable storage medium including computer readable instructions for detecting voice activity of a user with an electronic device, wherein the instructions when executed by a processor of the electronic device cause the electronic device to perform the following operations including: receiving a biosignal containing biosignal data from an biosensor; determining, with a voice activity detection module (VADM) of the electronic device, whether the voice of the user is active based at least on an analysis of the biosignal data; and when the VADM determines that the voice of the user is active, causing an audio sensor of the electronic to turn ON from an OFF or low power state, and to record an acoustic environment proximate the electronic device.

### Example 32

This example includes any or all of the features of example 31, wherein the electronic device includes an audio sensor, and the instructions when executed further cause the electronic device to perform the following operations including: determining a value of at least one characteristic of the biosignal data; and comparing the value of the at least one characteristic of the biosignal data to a first threshold; wherein: when the value of the at least one characteristic of the biosignal data is greater than or equal to the first threshold, the method further includes: causing the audio sensor to produce an audio signal containing audio data corresponding to the acoustic environment; and when the value of the at least one characteristic of the biosignal data is less than the first threshold, the audio sensor remains in the OFF or low power state.

### Example 33

This example includes any or all of the features of example 32, wherein determining the value of the at least one characteristic of the biosignal data includes averaging a plurality of individual values of the biosignal data over a period of time.

### Example 34

This example includes all or a portion of the features of example 33, wherein: each of the plurality of individual values includes a voltage; the value of the biosignal data is an average scalar value; and determining the value of the at least one characteristic of the biosignal data includes: converting the voltage of each of the plurality of individual values to a corresponding of scalar value, resulting in a plurality of scalar values; and averaging the plurality of scalar values to determine the average scalar value.

### Example 35

This example includes any or all of the features of example 32, wherein the instructions when executed cause the electronic device to produce the biosignal signal in response to movement of a body part of the user.

### Example 36

This example includes any or all of the features of example 35, wherein the body part includes at least a portion of a face of the user.

### Example 37

This example includes any or all of the features of example 36, wherein the body part includes a lower part of a face of the user.

### Example 38

This example includes any or all of the features of any one of examples 31 to 37, wherein the biosignal data includes electroencephalography data, electromyography data, or a combination thereof.

### Example 39

This example includes any or all of the features of example 32, wherein the instructions when executed cause the electronic device to detect the voice activity of the user based at least in part on the audio data.

### Example 40

This example includes any or all of the features of example 32, wherein when the value of the at least one characteristic of the biosignal data is greater than or equal to the first threshold, the instructions when executed further cause the electronic device to perform the following operations including: comparing an intensity value of the audio data to a second threshold; confirming that voice activity of the user is present when the intensity of the sampled audio signal is greater than or equal to the second threshold; and denying that voice activity of the user is present when the intensity of the sampled audio signal is less than the second threshold.

### Example 41

This example includes any or all of the features of example 40, wherein the intensity value is an average of a plurality of individual intensity values measured over a defined period of time.

### Example 42

This example includes any or all of the features of example 41, wherein: when voice activity of the user is confirmed, the instructions when executed further cause the performance of the following operations including: initiating the capture of the voice of the user with the audio sensor; and when voice activity of the user is denied, the instructions when executed further cause the perform lance of the following operations including: returning to monitoring the biosignal.

### Example 43

This example includes any or all of the features of any one of examples 31 to 42, wherein the electronic device is a mobile electronic device.

### Example 44

This example includes any or all of the features of example 43, wherein the mobile electronic device is a wearable electronic device.

### Example 45

This example includes any or all of the features of example 44, wherein the wearable electronic device is selected from the group consisting of eyewear, a watch, a belt buckle, a bracelet, a tie, and a pin.

### Example 46

According to this example there is provided a device that is configured to perform a method in accordance with any one of examples 16 to 30.

### Example 47

According to this example there is provided a computer readable storage medium comprising computer readable instructions for detecting voice activity of a user with an electronic device, wherein said instructions when executed by a processor of said electronic device cause the electronic device to perform a method in accordance with any one of claims 16 to 30.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

What is claimed is:

1. A voice activity detection system, comprising:
a processor;
a memory;
a biosensor;
an audio sensor; and
a voice activity detection module (VADM), wherein the VADM is to:
receive biosignal data recorded by said biosensor
determine whether a voice of a user of an electronic device is active based at least in part on an analysis of said biosignal data; and
when said VADM determines that the voice of said user is active, said VADM is to cause said audio sensor to capture audio data from an acoustic environment proximate said electronic device.

2. The voice activity detection system of claim 1, wherein:
said biosensor is in wired or wireless communication with said voice activity detection system and produces an biosignal containing said biosignal data; and
said VADM is further to receive said biosignal and determine whether the voice of said user is active based at least in part on the biosignal data in said biosignal.

3. The voice activity detection system of claim 1, wherein:
the VADM is to determine whether the voice of said user is active based at least in part on a comparison of a value of at least one characteristic of said biosignal data to a first threshold; and
when the VADM determines that the value of said at least one characteristic of said biosignal data meets or exceeds the first threshold, it causes said audio sensor to turn ON and produce an audio signal containing audio data corresponding to said acoustic environment; and
when the VADM determines that the value of said at least one characteristic of said biosignal data is less than the first threshold, the audio sensor remains in said OFF or low power state.

4. The voice activity detection system of claim 3, wherein:
the value of said at least one characteristic of said biosignal data is an average of a plurality of individual values of said biosignal data determined over a defined period of time;
each of said plurality of individual values comprises a voltage;
said value of said biosignal data is an average scalar value; and
said average scalar value corresponds to an average of the voltage of each of said plurality of individual values.

5. The voice activity detection system of claim 1, wherein said biosignal data corresponds to movement of a body part of said user.

6. The voice activity detection system of claim 1, wherein said biosignal data comprises electroencephalography data, electromyography data, or a combination thereof.

7. The voice activity detection system of claim 3, wherein:
the VADM is further to determine whether the voice of said user is active based at least in part on said audio data;
when said value of said at least one characteristic of said biosignal data meets or exceeds said first threshold, the VADM is further to:
compare an intensity value of said audio data to a second threshold;
confirm that voice activity of said user is present when said intensity value of said audio data is greater than or equal to said second threshold; and
deny that voice activity of said user is not present when said intensity value of said audio data is less than said second threshold.

8. The voice activity system of claim 1, wherein said system is in the form of a mobile electronic device.

9. The voice activity system of claim 8, wherein said mobile electronic device is a wearable electronic device.

10. A method of detecting the activity of a voice of a user with electronic device, comprising:
receiving a biosignal containing biosignal data from an biosensor;
determining, with a voice activity detection module (VADM) of said electronic device, whether the voice of said user is active based at least on an analysis of said biosignal data; and
when said VADM determines that the voice of said user is active, causing an audio sensor of said electronic to turn ON from an OFF or low power state, and to record an acoustic environment proximate said electronic device.

11. The method of claim 10, wherein said VADM determines whether the voice of a user is active at least in part by:
determining a value of at least one characteristic of said biosignal data; and
comparing the value of said at least one characteristic of said biosignal data to a first threshold;
wherein:
when said value of said at least one characteristic of said biosignal data is greater than or equal to said first threshold, the method further comprises:
causing said audio sensor to produce an audio signal containing audio data corresponding to said acoustic environment; and
when said value of said at least one characteristic of said biosignal data is less than said first threshold, said audio sensor remains in said OFF or low power state.

12. The method of claim 11, wherein:
determining the value of the at least one characteristic of said biosignal data comprises averaging a plurality of individual values of said biosignal data over a period of time;
each of said plurality of individual values comprises a voltage;
said value of said biosignal data is an average scalar value; and
determining the value of the at least one characteristic of said biosignal data comprises:
converting the voltage of each of said plurality of individual values to a corresponding of scalar value, resulting in a plurality of scalar values; and
averaging said plurality of scalar values to determine said average scalar value.

13. The method of claim 11, further comprising producing said biosignal signal in response to movement of a body part of said user.

14. The method of claim 10, wherein said biosignal data comprises electroencephalography data, electromyography data, or a combination thereof.

15. The method of claim 11, wherein when said value of at least one characteristic of said biosignal data is greater than or equal to said first threshold, the method further comprises:
comparing an intensity value of said audio data to a second threshold;
confirming that voice activity of said user is present when said intensity of said sampled audio signal is greater than or equal to said second threshold; and
denying that voice activity of said user is present when said intensity of said sampled audio signal is less than said second threshold.

16. The method of claim 15, wherein:
when voice activity of the user is confirmed, the method further comprises initiating the capture of the voice of said user with said audio sensor; and
when voice activity of the user is denied, the method further comprises returning to monitoring said biosignal.

17. The method of claim 10, wherein said electronic device is a mobile electronic device.

18. A computer readable storage medium comprising computer readable instructions for detecting voice activity of a user with an electronic device, wherein said instructions when executed by a processor of said electronic device cause the electronic device to perform the following operations comprising:
receiving a biosignal containing biosignal data from an biosensor;
determining, with a voice activity detection module (VADM) of said electronic device, whether the voice of said user is active based at least on an analysis of said biosignal data; and
when said VADM determines that the voice of said user is active, causing an audio sensor of said electronic to turn ON from an OFF or low power state, and to record an acoustic environment proximate said electronic device.

19. The computer readable storage medium of claim 18, wherein said electronic device comprises an audio sensor, and said instructions when executed further cause said electronic device to perform the following operations comprising:
determining a value of at least one characteristic of said biosignal data; and
comparing the value of said at least one characteristic of said biosignal data to a first threshold;
wherein:
when said value of said at least one characteristic of said biosignal data is greater than or equal to said first threshold, the method further comprises:
causing said audio sensor to produce an audio signal containing audio data corresponding to said acoustic environment; and
when said value of said at least one characteristic of said biosignal data is less than said first threshold, said audio sensor remains in said OFF or low power state.

20. The computer readable storage medium of claim 19, wherein:
determining the value of the at least one characteristic of said biosignal data comprises averaging a plurality of individual values of said biosignal data over a period of time;
each of said plurality of individual values comprises a voltage;
said value of said biosignal data is an average scalar value; and
determining the value of the at least one characteristic of said biosignal data comprises:
converting the voltage of each of said plurality of individual values to a corresponding of scalar value, resulting in a plurality of scalar values; and
averaging said plurality of scalar values to determine said average scalar value.

21. The computer readable storage medium of claim 19, wherein said instructions when executed cause said electronic device to produce said biosignal signal in response to movement of a body part of said user.

22. The computer readable storage medium of claim 18, wherein said biosignal data comprises electroencephalography data, electromyography data, or a combination thereof.

23. The computer readable storage medium of claim 19, wherein when said value of the at least one characteristic of the biosignal data is greater than or equal to said first threshold, said instructions when executed further cause said electronic device to perform the following operations comprising:
comparing an intensity value of said audio data to a second threshold;
confirming that voice activity of said user is present when said intensity of said sampled audio signal is greater than or equal to said second threshold; and
denying that voice activity of said user is present when said intensity of said sampled audio signal is less than said second threshold.

24. The computer readable storage medium of claim 23, wherein:
when voice activity of the user is confirmed, the instructions when executed further cause the performance of the following operations comprising: initiating the capture of the voice of said user with said audio sensor; and
when voice activity of the user is denied, the instructions when executed further cause the performance of the following operations comprising: returning to monitoring said biosignal.

25. The computer readable storage medium of claim 18, wherein said electronic device is a mobile electronic device.
